(19) United States
(12) Patent Application Publication
(10) Pub. No.: US 2019/0376318 A1
(43) Pub. Date: Dec. 12, 2019

(54) MODULAR DOOR LATCH ASSEMBLY

(71) Applicant: GALLERY SPECIALTY HARDWARE LTD., Downsview (CA)

(72) Inventor: Bradley Armstrong Cook, Oshawa (CA)

(21) Appl. No.: 16/434,248

(22) Filed: Jun. 7, 2019

Related U.S. Application Data
(60) Provisional application No. 62/682,412, filed on Jun. 8, 2018.

(51) Int. Cl. E05B 55/00; E05B 9/08

(52) U.S. Cl. CPC E05B 55/005; E05Y 2900/132; E05B 9/08

(57) ABSTRACT

A cylindrical chassis module for mounting within a primary bore hole of a door is described herein. The cylindrical chassis module includes a cylindrical housing having a front face and a rear face opposed to the front face, each of the front face and the rear face defining a face opening for receiving a spindle-based driver of a door knob assembly, an annular wall extending between the front face and the rear face and defining an annular wall opening for receiving the connecting member of a latch tube assembly. The cylindrical chassis module also includes a locking mechanism disposed within the housing, the locking mechanism configured to couple to the spindle-based driver through the first opening and couple to a connecting member of a latch tube assembly through the second opening such that rotation of the spindle-based driver retracts the connecting member of the latch tube assembly. Modular door latch assemblies and methods of installing modular door latch assemblies are also described herein.

### CROSS-REFERENCE TO RELATED APPLICATION

This application claims the benefit of U.S. Provisional Patent Application No. 62/682,412, filed Jun. 8, 2018 and the entire content of U.S. Provisional Patent Application No. 62/682,412 is hereby incorporated by reference.

### TECHNICAL FIELD

The embodiments disclosed herein relate to door latch assemblies and, in particular to door latch assemblies suitable for mounting on door with pre-drilled bore holes.

### BACKGROUND

Door latch assemblies are used in diverse applications. Most interior and exterior doors are prepped with a primary bore hole that extends through the door for mounting a door latch assembly including a door knob or lever or trim mechanism. Most primary bore holes for doors are pre-drilled in a circular shape. A cross bore that extends from the edge of the door through to the primary bore hole is also drilled into the door for the installation of the door latch assembly.

Door latch assemblies are typically classified into two types: tubular door latch assemblies and cylindrical door latch assemblies.

Tubular door latch assemblies, such as the tubular door latch assembly shown in FIG. 1, typically include a latch tube housing inserted into a cross bore of a door with the actuating/rotating mechanism of the latch tube housing extending into the vacant primary bore hole for engagement with a door knob. The actuating mechanism is therefore a free end in the primary bore hole that causes the knob/lever/trim mechanism to loosen easily and the tubular door latch assembly to be prone to damage upon repeatedly pushing and pulling the door knob to open and close the door.

Cylindrical door latch assemblies typically include a latch tube assembly mounted in the cross bore of the door and a main chassis assembly mounted through the bore hole of the door. The main chassis assembly is inserted into the primary bore hole of the door and engages a tailpiece of the latch tube assembly.

Cylindrical door latch assemblies are typically more technical and time consuming to install and more expensive than tubular door latch assemblies. Tubular latch assemblies offer cost savings over cylindrical door latch assemblies and offer more readily available modular knob, lever and/or trim design options because the functional and operational mechanisms are built into the tubular latch. In comparison, the functional and operations mechanisms of cylindrical door latch assemblies are built into the main chassis assembly and therefore have to be positioned relative to any knob, lever and/or trim components.

Cylindrical door latch assemblies offer some advantages over tubular door latch assemblies. For instance, cylindrical door latch assemblies are more robustly built and durable when compared to tubular latch assemblies. This is due to the functional and operational mechanisms of cylindrical door latch assemblies being housed in the main chassis in the primary bore hole of the door. The greater volume offered by the primary bore hole when compared with the cross bore hole provides for vital functional and operational internal components of cylindrical door latch assemblies to be larger and more robust.

Accordingly, there is a need for a door latch assembly that provides support that is better than that of conventional tubular door latch assemblies when mounted in a pre-drilled primary bore hole, particularly of an interior door, and is less expensive to install than conventional cylindrical door latch assemblies, and still allows for the extensive design choices typically associated with tubular latch assemblies.

### SUMMARY

A modular door latch assembly is described herein. The modular door latch assembly includes a latch tube module for inserting into a cross bore hole of a door extending inwardly from a side edge of the door to a primary bore hole. The latch tube module includes a tubular housing having an outside end having an outside opening and being shaped to support the housing against the side edge of the door when the housing is mounted in the cross bore, an inside end opposed to the outside end, the inside end having an inside opening and being shaped to extend inwardly towards the primary bore hole when the body is mounted in the cross bore hole, and an inner wall extending between the inside opening and the outside opening defining a channel extending through the tubular housing. The latch tube module also includes a latch bolt configured to extend outwardly through the outside opening and slidingly mounted within the channel of the tubular housing for extension and retraction along a longitudinal axis to latch the door to a door frame, and a connecting member coupled to the latch bolt and configured to extend inwardly through the inside opening towards the primary bore hole. The modular door latch assembly also includes a cylindrical chassis module for mounting within a bore hole of the door. The cylindrical chassis module includes a cylindrical housing having a front face and a rear face opposed to the front face, each of the front face and the rear face defining a face opening for receiving a spindle-based driver of a door knob assembly, an annular wall extending between the front face and the rear face and defining an annular wall opening for receiving the connecting member of a latch tube assembly; and a locking mechanism disposed within the housing, the locking mechanism configured to couple to the spindle-based driver through the face opening and couple to the connecting member through the annular wall opening such that rotation of the spindle-based driver retracts the connecting member and the bolt to unlatch the door.

According to some embodiments, the locking mechanism may comprise a ball bearing or spring clip extending radially towards a channel of the cylindrical housing to engage and retain the spindle based driver.

According to some embodiments, the locking mechanism comprises a first engaging member extending between the front face and the rear face of the cylindrical chassis module and a second engaging member extending between the front face and the rear face of the cylindrical chassis module, each of the first and second engaging members having a first end and a second end, the first ends adjacent to the front face and the second ends adjacent to the rear face, the first ends being spaced apart from each other to receive the connecting member of the latch tube assembly therebetween.

According to some embodiments, at least a portion of the connecting member extends between the first and second engagement members and rests against an inner face of the first and second engagement members to operatively couple the cylindrical chassis module to the latch tube module.

According to some embodiments, at least a portion of each of the first ends of the first and second engagement members bend inwardly towards a rotational axis of the spindle-based driver to retain the connecting member of the latch tube assembly in the operative coupling with the cylindrical chassis module.

The aperture may be sized and shaped to receive a standard 8 mm spindle.

A plurality of protrusions may extend from the front face for receiving a door knob assembly. Alternatively, the plurality of protrusions may extend from the rear face for receiving a door knob assembly.

The outer annular wall may be sized and shaped to mimic a standard primary bore hole for interior doors having diameter in a range of about 1½ to 2⅛ inches.

According to some embodiments, the inside end is sized and shaped to mimic a standard cross bore hole for interior doors having diameter in a range of about ⅞ to 1 inch.

Also described herein is a cylindrical chassis module for mounting within a primary bore hole of a door is described herein. The cylindrical chassis module includes a cylindrical housing having a front face and a rear face opposed to the front face, each of the front face and the rear face defining a face opening for receiving a spindle-based driver of a door knob assembly, an annular wall extending between the front face and the rear face and defining an annular wall opening for receiving the connecting member of a latch tube assembly. The cylindrical chassis module also includes a locking mechanism disposed within the housing, the locking mechanism configured to couple to the spindle-based driver through the first opening and couple to a connecting member of a latch tube assembly through the second opening such that rotation of the spindle-based driver retracts the connecting member of the latch tube assembly.

A method of installing a door latch assembly is also described herein. The method includes inserting a latch tube module into a cross bore of a door, the latch tube module having a connecting member extending from an end of the latch tube module, into a main bore hole of the door when the latch tube module is inserted into the cross bore; inserting a cylindrical chassis module into the main bore hole to engage the connecting member of the latch tube module, the cylindrical chassis module having a housing and a locking mechanism disposed within the housing, the locking mechanism configured to couple with a the spindle-based driver through a face opening and couple to the connecting member through an annular wall opening of the housing such that rotation of the spindle-based driver retracts the connecting member to unlatch the door; and inserting the spindle-based driver into the cylindrical chassis module through the face opening to engage the locking mechanism.

Other aspects and features will become apparent, to those ordinarily skilled in the art, upon review of the following description of some exemplary embodiments.

### BRIEF DESCRIPTION OF THE DRAWINGS

The drawings included herewith are for illustrating various examples of articles, methods, and apparatuses of the present specification. In the drawings:

FIG. 1 is a front view of a prior art latch tube module for mounting in a cross bore hole of a door, according to one embodiment;

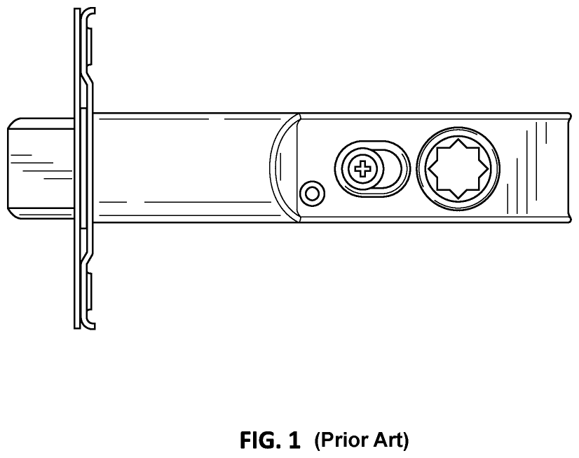

FIG. 2A is an exploded view of a cylindrical chassis module, latch tube module and door knob assembly, according to one embodiment;

FIG. 2B is an exploded view of a cylindrical chassis module, latch tube module and door knob assembly, according to another embodiment;

FIG. 3 is a rear view of the cylindrical chassis module and latch tube module of FIG. 2;

FIG. 4 is a perspective view of the cylindrical chassis module shown in FIG. 2;

FIG. 5. is a side view of the cylindrical chassis module shown in FIG. 2;

FIG. 6 is a cross-sectional view of the cylindrical chassis module of FIG. 5 along the line A-A;

FIG. 7 is a rear view of a portion of the cylindrical chassis module of FIG. 5 coupled to the latch tube assembly of FIG. 2;

FIG. 8 is a side view of the door knob assembly of FIG. 2 coupled to the cylindrical chassis module shown in FIG. 2; and

FIG. 9 is a schematic diagram of a method of installing a door latch assembly, according to one embodiment.

The drawings included herewith are for illustrating various examples of articles, methods, and apparatuses of the teaching of the present specification and are not intended to limit the scope of what is taught in any way.

### DETAILED DESCRIPTION

Various apparatuses or processes will be described below to provide an example of each claimed embodiment. No embodiment described below limits any claimed embodiment and any claimed embodiment may cover processes or apparatuses that differ from those described below. The claimed embodiments are not limited to apparatuses or processes having all of the features of any one apparatus or process described below or to features common to multiple or all of the apparatuses described below.

Terms of degree such as “about” and “approximately” as used herein mean a reasonable amount of deviation of the modified term such that the end result is not significantly changed. These terms of degree should be construed as including a deviation of at least ±5% or at least ±10% of the modified term if this deviation would not negate the meaning of the word it modifies.

The terms “an embodiment,” “embodiment,” “embodiments,” “the embodiment,” “the embodiments,” “one or more embodiments,” “some embodiments,” and “one embodiment” mean “one or more (but not all) embodiments of the present invention(s),” unless expressly specified otherwise.

The terms “including,” “comprising” and variations thereof mean “including but not limited to,” unless expressly specified otherwise. A listing of items does not imply that any or all of the items are mutually exclusive, unless expressly specified otherwise. The terms “a,” “an” and “the” mean “one or more,” unless expressly specified otherwise.

As used herein and in the claims, two or more parts are said to be “coupled”, “connected”, “attached”, or “fastened” where the parts are joined or operate together either directly or indirectly (i.e., through one or more intermediate parts), so long as a link occurs. As used herein and in the claims, two or more parts are said to be “directly coupled”, “directly connected”, “directly attached”, or “directly fastened” where the parts are connected in physical contact with each other. None of the terms “coupled”, “connected”, “attached”, and “fastened” distinguish the manner in which two or more parts are joined together.

Furthermore, it will be appreciated that for simplicity and clarity of illustration, where considered appropriate, reference numerals may be repeated among the figures to indicate corresponding or analogous elements. In addition, numerous specific details are set forth in order to provide a thorough understanding of the example embodiments described herein. However, it will be understood by those of ordinary skill in the art that the example embodiments described herein may be practiced without these specific details. In other instances, well-known methods, procedures, and components have not been described in detail so as not to obscure the example embodiments described herein. Also, the description is not to be considered as limiting the scope of the example embodiments described herein.

Described herein are embodiments of a modular door latch assembly that comprises two modules which are assembled together during installation into a door: a cylindrical chassis module and a latch tube assembly module. These modules will be discussed separately, prior to a discussion about their installation into a door.

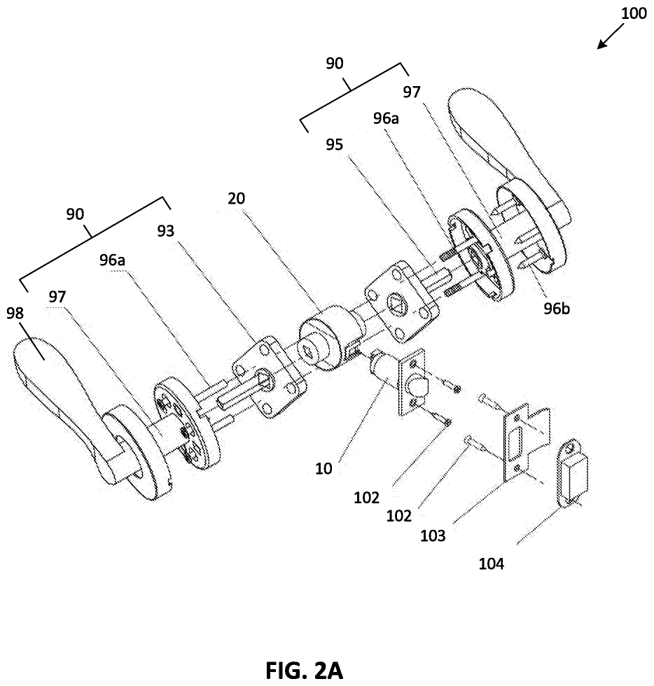

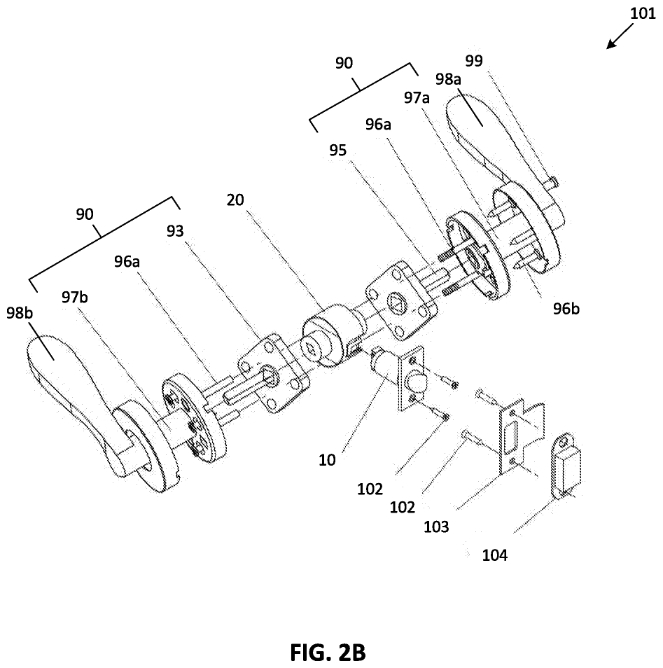

Referring now to FIG. 2A, illustrated therein is an exploded view of a door latch assembly 100, according to one embodiment. The door latch assembly 100 includes a latch tube module 10, a cylindrical chassis module 20 and a door knob assembly 90. The cylindrical chassis module 20 is shaped to be mounted into a pre-drilled primary bore hole of a door, such as but not limited to an interior door. The primary bore hole is typically drilled through door (e.g. from a front face of the door to a back face of the door) adjacent to an edge of the door for placement of the cylindrical chassis module 20 therein. In construction, the cylindrical chassis module 20 may be received in the primary bore hole of the door using an interference fit such that the cylindrical chassis module 20 is held substantially fixed with respect to the door.

The cylindrical chassis module 20 may couple to door knob assembly 90 via one or more spring bases 93 having a spindle 95. Connecting screws (or bolts) 96a may insert into apertures defined by the spring base 93 to couple a lever assembly 97 (e.g. an inner or an outer lever assembly) to the spring base. Lever assembly 97 is coupled to a lever or handle 98 by, for example, mounting screws 96b. In the embodiment shown in FIG. 2B, door latch assembly 101 includes an inner lever assembly 97a and an outer lever assembly 97b. Inner lever assembly 97a includes a push button 99 for locking the outer lever 98b. Outer lever 98b may be unlocked by turning the inner lever 98a or closing the door, for example.

A cross bore hole is drilled through the edge of the door to meet the primary bore hole to receive the latch tube module 10 during installation of the door latch assembly 100 or door latch assembly 101. Latch tube module 10 may be fixed to the edge of a door by self-tapping screws 102 for example. Latch tube module 10 may engage a strike plate 103. Strike plate 103 may be coupled to a decorate box 104 via self-tapping screws 102.

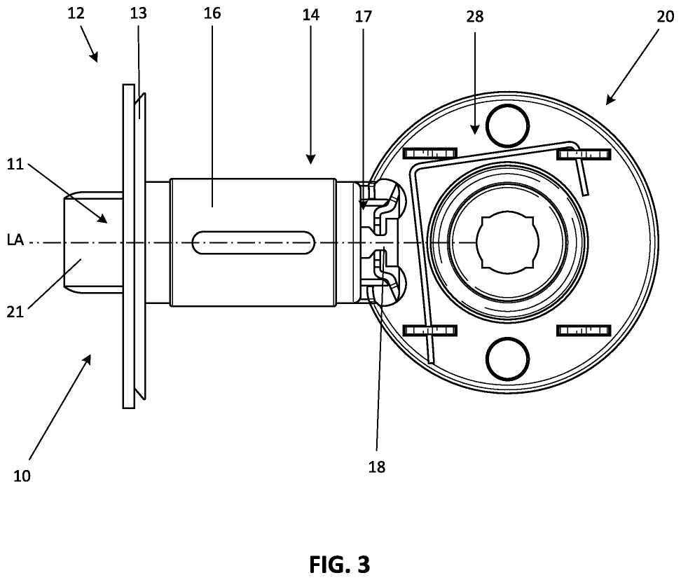

Turning to FIG. 3, illustrated therein is a latch tube module 10 coupled to a cylindrical chassis module 20, according to one embodiment. Latch tube module 10 is for mounting within a cross bore hole of a door and engaging with a door frame plate (such as strike plate 103 and/or decorate box 104) to latch the door. Cylindrical chassis module 20 is for mounting in a primary bore hole of the door and engaging with the door latch assembly 100 for using to latch and un-latch the door. In some embodiments, the cross bore hole is a standard cross bore hole with a diameter in a range of about ⅞ to 1 inch. The cross bore hole is generally vertically positioned along edge of the door such that a centerline of the cross bore hole intersects a center of the primary bore hole.

Latch tube module 10 shown in FIG. 3 has a housing 16 having an outside end 12 and an inside end 14. Outside end 12 has an outside opening 11 and an out-turned rectangular flange 13 for supporting the latch tube module against an edge of a door. Inside end 14 has an inside opening 17 and is shaped for inserting through a cross bore hole of a door.

Latch tube module 10 also has a connecting member 18 for coupling the latch tube module 10 to the cylindrical chassis module 20. Connecting member 18 extends through inside opening 17 defined by housing 16 at inside end 14. In the embodiment shown in the drawings, connecting member 18 has a “T” shape for engaging and operatively coupling the latch tube module 10 to the cylindrical chassis 20.

Latch tube module 10 also includes a bolt 21 slidingly mounted within the channel (not shown) of housing 16. Bolt 21 is configured to extend through the out-turned rectangular flange 13 and the outside opening 11 for extension and retraction along a longitudinal axis LA. Bolt 21 is for latching and unlatching the door to a door frame plate. Bolt 21 is slidingly mounted to housing 16 to retract and extend between a first position where the bolt 21 extends through the outside opening 11 of the latch tube housing 16 towards the door frame plate and a second position where the bolt 21 is retracted to be substantially inside of the channel of housing 16. In the embodiment shown in the Figures, bolt 21 is operatively coupled to connecting member 18 such that extension and retraction of connecting member 18 provides for extension and retraction of bolt 21, respectively.

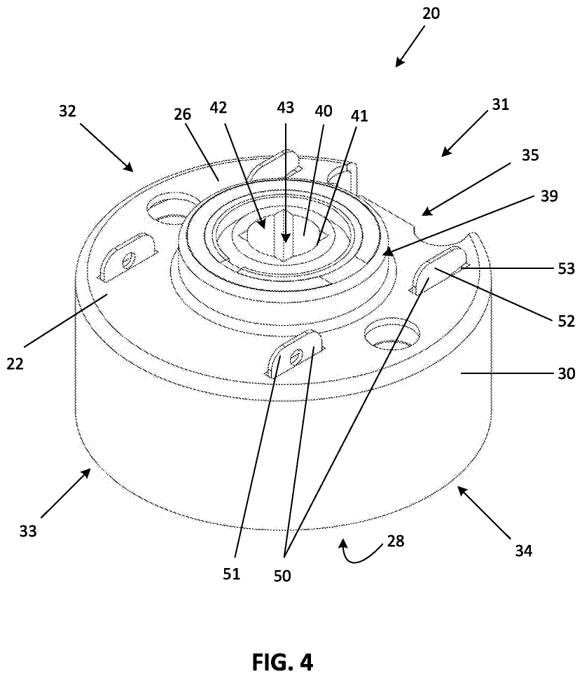

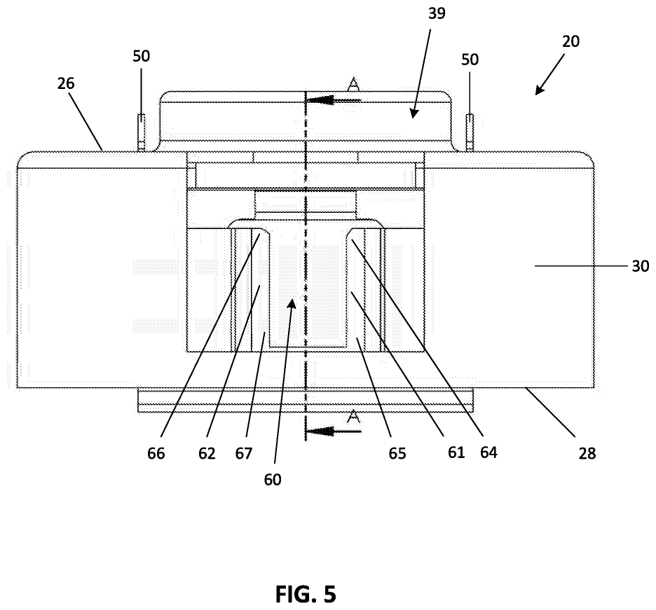

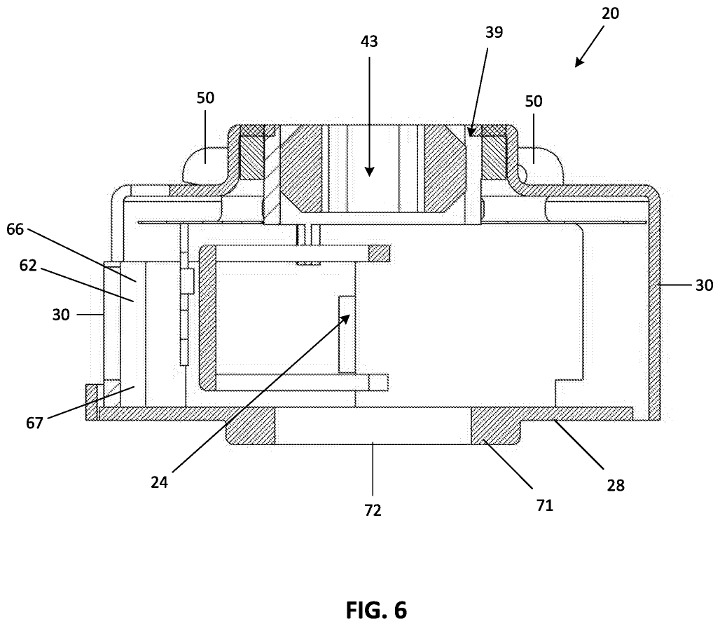

Turning now to FIG. 4, cylindrical chassis module 20 includes a housing 22 for supporting a locking mechanism 24 (see FIGS. 5 and 6) disposed therein. Housing 22 has a front face 26 and a rear face 28 opposed to the front face 26. Front face 26 and rear face 28 are connected by an annular wall 30 extending around a periphery of the housing 22. Annular wall 30 generally has a first section 31, a second section 32, a third section 33 and a fourth section 34. First section 31 defines an opening 35 that extends inwards from the annular wall 30 towards locking mechanism 24. When the cylindrical chassis module 20 is mounted in a door, cylindrical chassis module 20 is positioned in the primary bore hole of the door such that first section 31 is adjacent an edge of the door to engage latch tube module 10.

In the embodiment shown in the drawings, first section 31 is positioned adjacent a right edge of the door at a position where the cross bore hole and the primary bore hole that are pre-drilled into the door meet. It will be understood that when first section 31 is positioned adjacent a right edge of the door (i.e. relative to a person facing the door), second section 32 may also be referred to as a top side of the cylindrical chassis module 20 and fourth section 34 may be referred to as a bottom side of the cylindrical chassis module 20. Correspondingly, when first section 31 is positioned adjacent a left edge of the door (i.e. relative to a person facing the door), fourth section 34 may also be referred to as a bottom side of the cylindrical chassis module 20 and second section 32 may be referred to as a top side of the cylindrical chassis module 20.

In the embodiments shown in the drawings, annular wall 30 extends between the front face 26 and the bottom face 28 around a periphery of the cylindrical chassis module 20 to form a perimeter of the cylindrical chassis module 10. Annular wall 24 also defines an outer edge 25 of chassis module 10. Annular wall 30 is generally smooth and is sized and shaped to mount within a standard primary bore hole of a door, such as but not limited to a prepped interior door. For example, when the chassis module 10 is mounted into a door, the annular wall 30 generally rests against an inner surface of the primary bore hole and provides an interference (e.g. friction) fit for the door latch assembly 100/101. In some embodiments, annular wall 30 is sized and shaped to be received in the primary bore of the door using an interference fit such that the cylindrical chassis module 20 is held substantially fixed with respect to the door. In the embodiments shown in the drawings, annular wall 30 is generally continuous around the perimeter of the cylindrical chassis module 20 and generally sized and shaped to mimic an inner surface of a primary bore hole of a door (not shown) to achieve the aforementioned interference fit.

In some embodiments, a standard primary bore hole of a door has a diameter in a range of about 1½ to 2⅛ inches and the center of the standard primary bore hole is located at or between about 2⅜ inches and 2¾ inches back from the edge of the door and the annular wall 30 is sized and shaped to rest against an inner surface of the primary bore hole. This distance is commonly known as the backset dimension. It will be appreciated that the size and shape of the annular wall 30 may vary from that described herein and still achieve an interference fit within a standard primary bore hole of a door as contemplated herein.

Each of front face 26 and rear face 28 are sized and shaped to co-ordinate with annular wall 30 to generally enclose locking mechanism 24. Each of the front face 26 and the rear face 28 engage with and/or receive a portion (e.g. a door knob) of door knob assembly 90 for latching and unlatching the door.

For instance, as shown in FIG. 4, first face 26 may include a cylindrical protrusion 39 for engaging a portion (e.g. a door knob) of door knob assembly 90. Cylindrical protrusion 39 has a front (e.g. face) opening 42 and an inner annular wall 40 extending therefrom inwardly to provide access to locking mechanism 24 for the spindle-based driver of the door knob assembly. In the embodiment shown in FIG. 4, inner annular wall 40 has a continuous inner edge 41 and extends inwardly from the front face 16 towards the rear face 28 to define a channel 43. Front opening 42 and channel 43 are for receiving a spindle-based driver (not shown) of the door knob assembly. In some embodiments, front opening 42 is sized and shaped to receive at least one spindle-based driver for rotationally coupling at least one door knob to the cylindrical chassis module 20. Channel 43 extends axially though the cylindrical chassis module 20 such that a spindle-based driver (not shown) inserted therein extends through channel 43 to engage with locking mechanism 24. In some embodiments, front aperture 42 and channel 43 may be sized and shaped to receive a standard 8 mm spindle.

The spindle-based driver is generally cylindrical and includes a first or outer end portion and a second or inner end portion. As described above, the cylindrical chassis module 20 includes a front aperture 42 through which the outer end portion of the spindle-based driver extends when door knob assembly is assembled. As would be understood by one of skill in the art, a clip or the like and a clip biasing member may be utilized to couple a handle of the door knob assembly to the spindle-based driver adjacent the outer end portion of the spindle-based driver such that the handle of the door knob assembly and the spindle-based driver are coupled for rotation together with respect to the cylindrical chassis module 20. When inserted into the channel 43, the spindle-based driver has an axis of rotation that is transverse to front face 26. In some embodiments, the axis of rotation of the spindle-based driver is perpendicular to front face 26.

In some embodiments, cylindrical protrusion 39 may include a threaded portion (not shown) for receiving a corresponding threaded portion of a door knob face plate.

Also shown in FIG. 4, first face 26 may include one or more secondary protrusions 50 for engaging a door knob, a faceplate or other component of a door knob assembly 90. Secondary protrusions 50 may have different configurations for engaging a door knob, a faceplate or other component of a door knob assembly 90. For example, in some embodiments secondary protrusions 50 may include one or more slot members 51 for receiving a portion of a door knob, a faceplate or other component of a door knob assembly 90. Slot member 51 may extend outwardly from front face 26 and have an aperture there through for retaining a portion of a door knob, a faceplate or other component of a door knob assembly 90. In other embodiments, secondary protrusions 50 may include one or more slot portions 52. Slot portions 52 extend from front face 26 and provide a groove 53 for slidingly receiving a portion a door knob, a faceplate or other component of a door knob assembly 90 in the notch between the hook portion and the front face 26.

Turning to FIGS. 5 and 6, also described above, annular wall 30 defines an opening 35 sized and shaped to provide access to a coupling assembly 60 of locking mechanism 24 for cylindrical chassis module 20 to couple to a latch tube module 10.

In the embodiments shown in the drawings, coupling assembly 60 comprises a first engaging member 61 and a second engaging member 62. Each of first engaging member 61 and a second engaging member 62 extends between front face 26 and the rear face 28 of the cylindrical chassis module 20. First engaging member 61 has a first end 64 and a second end 65, while second engaging member 62 has a first end 66 and a second end 67. Each of the first ends 64, 66 are adjacent to the front face 26 and the second ends 65, 67 are adjacent to the rear face 28. First engaging member 61 and second engaging member 62 are connected to each other at second ends 65, 67 and spaced apart from each other at first ends 64, 66. First ends 64, 66 combine to form a U-shaped opening to receive connecting member 18 of the latch tube module 10.

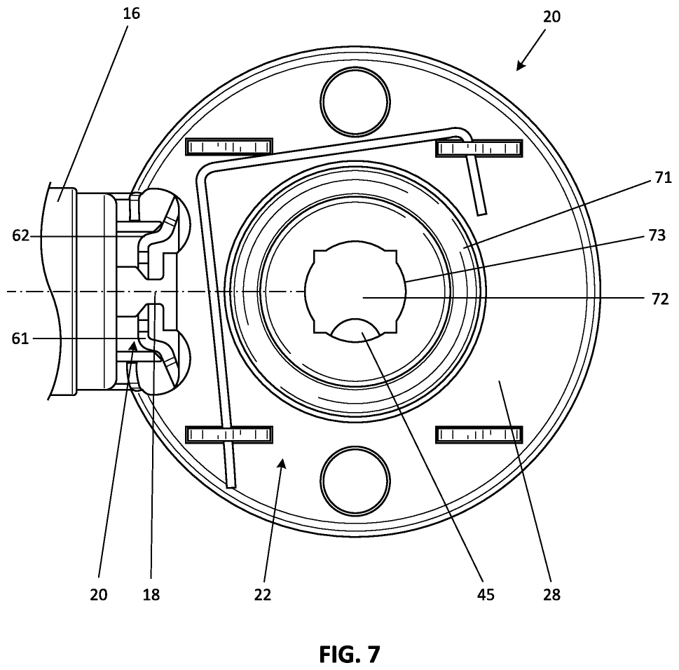

In one embodiment, as shown in FIG. 7, when the latch tube module 10 is coupled to cylindrical chassis module 20, at least a portion of the connecting member 18 extends between the first and second engagement members 61, 62 and rests against an inner face (not shown) of each of the first and second engagement members 61, 62 when coupled thereto.

Upon rotation of the spindle-based driver (not shown) engaging locking mechanism 24, locking mechanism 24 converts the rotational motion of the spindle-based driver to lateral motion to retract the coupling assembly 60 of cylindrical chassis module 20. When coupling assembly 60 is engaging connecting member 18 of the latch tube module 10, bolt 21 of latch tube module 10 is retracted within housing 16 of latch tube module 10. A biasing member (e.g. a spring, not shown) positioned within housing 16 biases the bolt 21 in an extended position extending from the outside end 12 to engage a door frame plate of a door jam. Upon rotation of the spindle-based driver, locking mechanism 24 retracts the coupling assembly 60 and connecting member 18 retracts bolt 21 within a housing 16. Upon removal of the rotation force imparted by the spindle-based driver, the spring biases the bolt 21 back to its extended position extending from the housing 16.

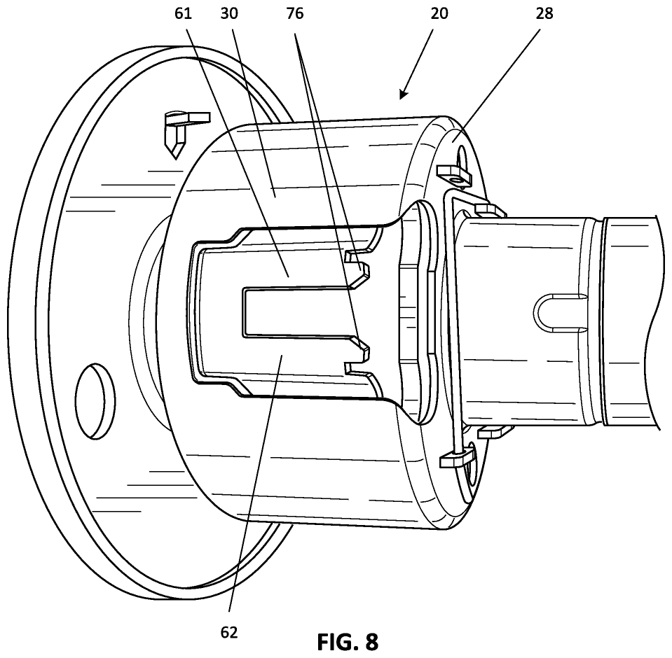

In one embodiment, at least a portion of each of the first ends 64, 66 of the first and second engagement members 61, 62, respectively, bend inwardly towards the rotational axis of the spindle-based driver to retain the connecting member 18 of the latch tube module 10 therebetween to form retention edges 76. These retention edges 46 are shown in FIG. 8 and are for retaining coupling of the latch tube module 10 to the cylindrical chassis module 20 and may retain the coupling of the latch tube module 10 to the cylindrical chassis module 20 by inhibiting movement (e.g. sliding movement) of the connecting member 18 with respect to the engagement members 61, 62 after the connecting member 18 extends between the first and second engagement members 61, 62 and rests against an inner face (not shown) of each of the first and second engagement members 61, 62 to couple thereto.

It will be appreciated that the aforementioned embodiment of the coupling assembly 60 is only one example of how cylindrical chassis module 20 can be configured to engage connecting member 18 of latch tube module 10.

Also shown in FIG. 7, illustrated therein is a rear face view of the cylindrical chassis module 20 of FIG. 4. In some embodiments, locking mechanism 24 may include a ball bearing 45 extending radially from inner annular wall 42 towards the channel 43 to engage the spindle-based driver and retain the spindle based driver in channel 43. Ball bearing 45 may also embodied as a spring clip. For instance, as shown in FIG. 7, ball bearing 45 is shown as extending from fourth section 34 towards second section 32. It will be understood that ball bearing 45 may also extend into channel 43 between any two opposed sections of cylindrical chassis module 20 to engage the spindle-based driver and retain the spindle based driver in channel 43.

Returning to FIG. 6, illustrated therein is a cross-section view along line A-A of FIG. 5 showing the internal components of locking mechanism 24. Opening 35 provides access to locking mechanism 24 of cylindrical chassis module 20. Locking mechanism 24 is substantially enclosed within housing 22 and configured to rotationally couple with a spindle-based driver of door knob assembly 90. Specifically, when cylindrical chassis module 20 is coupled to latch tube module 10, locking mechanism 24 couples to provide for converting rotational motion of the spindle-based driver (i.e. a door knob coupled thereto) to lateral retraction of bolt 21 of latch tube module 10 (as described above). Rotating the spindle-based driver internally transfers the rotating motion into linear motion, thereby pulling back and retracting bolt 21 when the cylindrical chassis module 20 is engaged with the latch tube module 10.

It should also be noted that, as shown in FIGS. 5-7, rear face 28 includes a rear protrusion 71 for engaging a portion of a door knob assembly. Rear protrusion 71 may also include a rear aperture 72 extending through the rear face 28 of housing 22 to provide access to the locking mechanism 24 for a the spindle-based driver of the door knob assembly. Aperture has a continuous inner edge 73 that protrudes from rear face 28 and extends inwardly from the rear face 28 towards the front face 26 to define the rear aperture 72. Rear aperture 72 is for receiving a spindle-based driver (not shown) of a door knob assembly of the door latch assembly 90. In some embodiments, rear aperture 72 connects to channel 43 and is sized and shaped to receive at least one spindle-based driver for rotationally coupling at least one door knob to the cylindrical chassis module 20. As previously stated, channel 43 extends axially though the cylindrical chassis module 20 such that a spindle-based driver (not shown) extends through the channel 43 to engage with locking mechanism 24 therein. For instance, rear aperture 72 and channel 43 may also be sized and shaped to receive a standard 8 mm spindle. Rear aperture 72 and channel 43 may also be sized and shaped to receive any other spindle/driver style or size.

In some embodiments, rear protrusion 71 may include a threaded portion (not shown) for receiving a corresponding threaded portion of a door knob face plate.

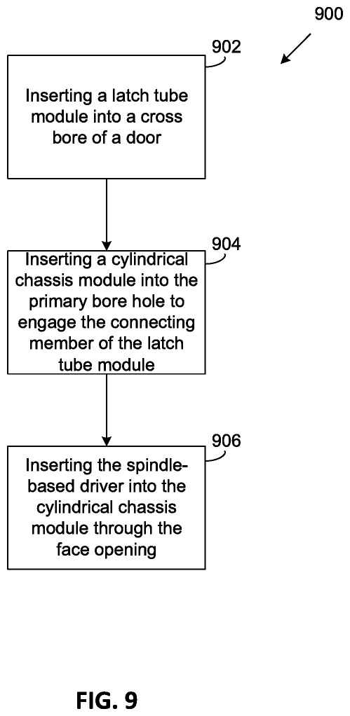

Turning to FIG. 9, illustrated therein is a method 900 of installing a door latch assembly.

At step 902, latch tube module 10 is inserted into a cross bore of a door. The latch tube module 10 has connecting member 18 extending from an end of the latch tube module 10 and the latch tube module 10 is inserted into the cross bore until the connecting member 18 protrudes into a primary bore hole of the door.

At step 904, cylindrical chassis module 20 is inserted into the primary bore hole to engage the connecting member 18 of the latch tube module 10. The cylindrical chassis module 20 has a housing 16 and a locking mechanism 24 disposed within the housing 16. The locking mechanism 24 is configured to couple with a spindle-based driver through a face opening 42 and couple to the connecting member 18 through an annular wall opening 35 of the housing 16 such that rotation of the spindle-based driver retracts the connecting member 18 to unlatch the door.

At step 906, the spindle-based driver is inserted into the cylindrical chassis module 10 through the face opening 42 to engage the locking mechanism 24. In some embodiments, the locking mechanism 24 comprises a ball bearing 45 extending radially towards a channel 43 of the housing 16 to engage and retain the spindle based driver. At step 906, the spindle-based driver is inserted into the cylindrical chassis module 10 through the face opening 42 to engage the ball bearing 45 to secure the spindle-based driver in the cylindrical chassis module 10.

It will therefore be appreciated from the above detailed description that a door latch assembly of modular construction is taught, in which the components of the door latch assembly can be pre-assembled prior to their installation into the pre-drilled bore holes of a door. The modular construction of the door latch assembly can include the outside and inside door handles, the tubular and chassis modules, as well as linkages between these components. The modular components can facilitate the assembly process by, for example, being of a design which simplifies the process of installing them into pre-drilled bore holes of a door, without requiring the use of specialized tools, thereby reducing the labor costs associated with assembly.

The door latch assembly can include the door handles as a separate modular component, thereby providing for door handles to be affixed to the door latch assembly. The pre-assembled nature of the modular components can eliminate the requirement for adjustments to be made during the installation of the modules into the door, thereby further minimizing assembly costs. The modular components of the door latch assembly in some embodiments can be adaptable for uses on a variety of different doors by merely switching outside door handles and providing different size linkages between the tubular and chassis assemblies.

While the above description provides examples of one or more apparatus, methods, or systems, it will be appreciated that other apparatus, methods, or systems may be within the scope of the claims as interpreted by one of skill in the art.

What is claimed is:

1. A modular door latch assembly comprising:
a) a latch tube module for inserting into a cross bore hole of a door extending inwardly from a side edge of the door to a primary bore hole, the latch tube module comprising:
a tubular housing having an outside end having an outside opening and being shaped to support the housing against the side edge of the door when the housing is mounted in the cross bore, an inside end opposed to the outside end, the inside end having an inside opening and being shaped to extend inwardly towards the primary bore hole when the body is mounted in the cross bore hole, and an inner wall extending between the inside opening and the outside opening defining a channel extending through the tubular housing;
a latch bolt configured to extend outwardly through the outside opening and slidingly mounted within the channel of the tubular housing for extension and retraction along a longitudinal axis to latch the door to a door frame; and
a connecting member coupled to the latch bolt and configured to extend inwardly through the inside opening towards the primary bore hole; and
b) a cylindrical chassis module for mounting within the primary bore hole of the door, the cylindrical chassis module comprising:
a cylindrical housing having a front face and a rear face opposed to the front face, each of the front face and the rear face defining a face opening for receiving a spindle-based driver of a door knob assembly, an annular wall extending between the front face and the rear face and defining an annular wall opening for receiving the connecting member of a latch tube assembly; and
a locking mechanism disposed within the housing, the locking mechanism configured to couple to the spindle-based driver through the face opening and couple to the connecting member through the annular wall opening such that rotation of the spindle-based driver retracts the connecting member and the bolt to unlatch the door.

2. The door latch assembly of claim 1, wherein the locking mechanism comprises a ball bearing or spring clip extending radially towards a channel of the cylindrical housing to engage and retain the spindle based driver.

3. The door latch assembly of claim 1, wherein the locking mechanism comprises a first engaging member extending between the front face and the rear face of the cylindrical chassis module and a second engaging member extending between the front face and the rear face of the cylindrical chassis module, each of the first and second engaging members having a first end and a second end, the first ends adjacent to the front face and the second ends adjacent to the rear face, the first ends being spaced apart from each other to receive the connecting member of the latch tube assembly therebetween.

4. The door latch assembly of claim 3, wherein at least a portion of the connecting member extends between the first and second engagement members and rests against an inner face of the first and second engagement members to operatively couple the cylindrical chassis module to the latch tube module.

5. The door latch assembly of claim 4, wherein at least a portion of each of the first ends of the first and second engagement members bend inwardly towards a rotational axis of the spindle-based driver to retain the connecting member of the latch tube assembly in the operative coupling with the cylindrical chassis module.

6. The door latch assembly of claim 1, wherein the aperture is sized and shaped to receive a standard 8 mm spindle.

7. The door latch assembly of claim 1, wherein a plurality of protrusions extend from the front face for receiving a door knob assembly.

8. The door latch assembly of claim 1, wherein a plurality of protrusions extend from the rear face for receiving a door knob assembly.

9. The door latch assembly of claim 1, wherein the outer annular wall is sized and shaped to mimic a standard primary bore hole for interior doors having diameter in a range of about 1½ to 2⅛ inches.

10. The door latch assembly of claim 1, wherein the inside end is sized and shaped to mimic a standard cross bore hole for interior doors having diameter in a range of about ⅞ to 1 inch.

11. A cylindrical chassis module for mounting within a primary bore hole of a door, the cylindrical chassis module comprising:
a cylindrical housing having a front face and a rear face opposed to the front face, each of the front face and the rear face defining a face opening for receiving a spindle-based driver of a door knob assembly, an annular wall extending between the front face and the rear face and defining an annular wall opening for receiving the connecting member of a latch tube assembly; and
a locking mechanism disposed within the housing, the locking mechanism configured to couple to the spindle-based driver through the first opening and couple to a connecting member of a latch tube assembly through the second opening such that rotation of the spindle-based driver retracts the connecting member of the latch tube assembly.

12. The chassis module of claim 11, wherein the locking mechanism comprises a ball bearing or a spring clip extending radially towards a channel of the cylindrical housing to engage and retain the spindle based driver.

13. The chassis module of claim 11, wherein the locking mechanism comprises a first engaging member extending between the front face and the rear face of the cylindrical chassis module and a second engaging member extending between the front face and the rear face of the cylindrical chassis module, each of the first and second engaging members having a first end and a second end, the first ends adjacent to the front face and the second ends adjacent to the rear face, the first ends being spaced apart from each other to receive the connecting member of the latch tube assembly therebetween.

14. The chassis module of claim 13, wherein at least a portion of the connecting member extends between the first and second engagement members and rests against an inner face of the first and second engagement members to operatively couple the cylindrical chassis module to the latch tube module.

15. The chassis module of claim 14, wherein at least a portion of each of the first ends of the first and second engagement members bend inwardly towards a rotational axis of the spindle-based driver to retain the connecting member of the latch tube assembly in the operative coupling with the cylindrical chassis module.

16. The chassis module of claim 11, wherein the aperture is sized and shaped to receive a standard 8 mm spindle.

17. The chassis module of claim 11, wherein a plurality of protrusions extend from the front face for receiving a door knob/lever/trim assembly.

18. The chassis module of claim 11, wherein a plurality of protrusions extend from the rear face for receiving a door knob/lever/trim assembly.

19. The chassis module of claim 11, wherein the outer annular wall is sized and shaped to mimic a standard primary bore hole for interior doors having diameter in a range of about 1½ to 2⅛ inches.

20. A method of installing a modular door latch assembly, the method comprising:
inserting a latch tube module into a cross bore hole of a door, the latch tube module having a connecting member extending from an end of the latch tube module into a primary bore hole of the door when the latch tube module is inserted into the cross bore hole;
inserting a cylindrical chassis module into the primary bore hole to engage the connecting member of the latch tube module, the cylindrical chassis module having a housing and a locking mechanism disposed within the housing, the locking mechanism configured to couple with a spindle-based driver of the cylindrical chassis module through a face opening and couple to the connecting member through an annular wall opening of the housing such that rotation of the spindle-based driver retracts the connecting member to unlatch the door; and
inserting the spindle-based driver into the cylindrical chassis module through the face opening to engage the locking mechanism.
